(19) United States
(12) Patent Application Publication
(10) Pub. No.: US 2011/0149206 A1
(43) Pub. Date: Jun. 23, 2011

(54) Polarizer and Liquid Crystal Display Comprising the Same

(75) Inventor: Pavel I. Lazarev, Menlo Park, CA (US)

(73) Assignee: CRYSOPTIX KK, Tokyo (JP)

(21) Appl. No.: 12/952,041

(22) Filed: Nov. 22, 2010

Related U.S. Application Data
(60) Provisional application No. 61/267,159, filed on Dec. 7, 2009.

(51) Int. Cl. G02F 1/13363; G02B 5/30; G02B 1/08

(52) U.S. Cl. 349/96; 359/489.01

(57) ABSTRACT

The disclosed polarizer comprises at least one substrate made of a birefringent material, and a polarizing plate located on the substrate. The substrate possesses anisotropic property of positive A-type and has a slow optical axis parallel to the substrate surface. The polarizing plate possesses anisotropic absorption of the electromagnetic radiation in at least one subrange of the visible spectral range, and a transmission axis of the polarizing plate and the slow optical axis of the substrate are directed substantially parallel to each other.

### CROSS REFERENCE TO RELATED APPLICATIONS

This application claims priority to U.S. provisional patent application No. 61/267,159 filed Dec. 7, 2009 pursuant to 35 U.S.C. 119(e), the disclosure of which is incorporated herein by reference in its entirety.

### FIELD OF THE INVENTION

The present invention generally relates to the components of liquid crystal display and more particularly to a polarizer.

### BACKGROUND OF THE INVENTION

Optical polarizer is widely used for increasing optical contrast in such products as liquid crystal displays (LCD).

One of the most commonly used types of polarizers for these applications is a dichroic polarizer which absorbs light of one polarization and transmits light of the other polarization. Dichroic polarizers may be made by incorporating a dye into a polymer matrix which is stretched in at least one direction. Dichroic polarizers may also be made by uniaxially stretching a polymer matrix and staining the matrix with a dichroic dye. Alternatively, a polymer matrix may be stained with an oriented dichroic dye. Dichroic dyes include anthraquinone and azo dyes, as well as iodine. Many commercial dichroic polarizers use polyvinyl alcohol as the polymer matrix for the dye.

One measure of performance for polarizers is their extinction ratio. The extinction ratio is a ratio of light transmitted by the polarizer in a preferentially transmitted polarization state to light transmitted in an orthogonal polarization state. These two orthogonal states are often related to the two linear polarizations of light. The extinction ratio of dichroic polarizers vary over a wide range depending on their specific construction and target application. For example, dichroic polarizers may have extinction ratio between 5:1 and 3000:1. Dichroic polarizers used in display systems typically have extinction ratio which is preferably greater than 100:1 and even 500:1. Dichroic polarizers may also be used with other optical devices, such as other types of reflective polarizers and mirrors [see, P. Yeh and C. Gu, Optics of Liquid Crystal Displays, (Wiley, New York, 1999)]. There is an increasing demand for polarizers due to the growing LCD market.

Requirements to durability and mechanical strength of all components of LCD are getting higher, especially with development of new application fields of displays. The conventional designs of polarizers for LCD comprise protecting substrates positioned on both sides of the polarizing plate. The protecting substrates are used to improve durability and mechanical stability of the polarizer. Triacetyl cellulose (TAC) is widely used as a material of the protecting substrate. This material possesses high transparency and good adhesion to the polarizing plate.

At the same time, TAC-substrate possesses a number of drawbacks in comparison with other polymer substrates, for example, birefringence substrate. TAC-substrate is a costly component; it has a low mechanical strength and hardness, high water absorption.

### SUMMARY OF THE INVENTION

In a first aspect of the present invention there is provided a polarizer comprising at least one substrate made of a birefringent material and a polarizing plate located on the substrate. The substrate possesses anisotropic property of positive A-type and has a slow optical axis parallel to the substrate surface. Said polarizing plate possesses anisotropic absorption of the electromagnetic radiation in at least one subrange of the visible spectral range, and a transmission axis of the polarizing plate and the slow optical axis of the substrate are directed substantially parallel to each other.

In a second aspect of the present invention there is provided a liquid crystal display comprising a liquid crystal cell, and front and rear polarizers arranged on each side of the liquid crystal cell. The polarizers have transmission axes which are perpendicular to each other. At least one of said polarizers comprises at least one substrate made of a birefringent material and a polarizing plate located on the substrate. The substrate possesses anisotropic property of positive A-type and has a slow optical axis parallel to substrate surface. The polarizing plate possesses anisotropic absorption of the electromagnetic radiation in at least one subrange of the visible spectral range, and a transmission axis of the polarizing plate and the slow optical axis of the substrate are directed substantially parallel to each other.

### BRIEF DESCRIPTION OF THE DRAWINGS

FIG. 1 shows the absorbance spectrum of 2,2′-disulfo-4,4′-benzidine terephthalamide-isophthalamide copolymer cesium salt; terephthalamide/isophthalamide molar ratio in the copolymer 50:50;

FIG. 2 shows the principal refractive indices' spectra of the organic retardation layer prepared with 2,2′-disulfo-4,4′-benzidine terephthalamide-isophthalamide copolymer cesium salt on a glass substrate; terephthalamide/isophthalamide molar ratio in the copolymer 50:50;

FIG. 3 shows the viscosity vs. shear rate dependence of 2,2′-disulfo-4,4′-benzidine terephthalamide-isophthalamide copolymer cesium salt aqueous solution; terephthalamide/isophthalamide molar ratio in the copolymer 50:50;

FIG. 4 schematically shows a liquid crystal display of a vertical alignment mode with polarizers based on PET substrate according to the present invention.

FIG. 5 shows a calculated viewing angle performance of the liquid crystal display shown in FIG. 4.

FIG. 6 schematically shows a liquid crystal display of an in-plane switching mode with polarizers based on PET substrate according to the present invention.

FIG. 7 shows a calculated viewing angle performance of the liquid crystal display shown in FIG. 6.

### DETAILED DESCRIPTION OF THE INVENTION

The general description of the present invention having been made, a further understanding can be obtained by reference to the specific preferred embodiments, which are given herein only for the purpose of illustration and are not intended to limit the scope of the appended claims.

Definitions of various terms used in the description and claims of the present invention are listed below.

The term “visible spectral range” refers to a spectral range having the lower boundary approximately equal to 400 nm, and upper boundary approximately equal to 750 nm.

The term “retardation layer” refers to an optically anisotropic layer which is characterized by three principal refractive indices (nₓ, n_{y} and n_{z}), wherein two principal directions for refractive indices nₓ and n_{y} belong to xy-plane coinciding with a plane of the retardation layer and one principal direction for refractive index (n_{z}) coincides with a normal line to the retardation layer, and wherein at least two of principal refractive indices are different.

The term “substrate possessing anisotropic property of positive A-type” refers to an uniaxial optic substrate which refractive indices nₓ, n_{y}, and n_{z} obey the following condition in the visible spectral range: n_{z}=n_{y}<nₓ.

The term “retardation plate of negative C-type” refers to an uniaxial optic retardation plate which refractive indices nₓ, n_{y}, and n_{z} obey the following condition in the visible spectral range: n_{z}<n_{y}=nₓ.

The term “retardation plate of negative A-type” refers to an uniaxial optic retardation plate which refractive indices nₓ, n_{y}, and n_{z} obey the following condition in the visible spectral range: nₓ<n_{y}=n_{z}.

The term “retardation plate of negative B_{A}-type” refers to an biaxial optic retardation plate which refractive indices nₓ, n_{y}, and n_{z} obey the following condition in the visible spectral range: nₓ<n_{z}<n_{y}.

The term “thickness retardation Rₜₕ” refers to a retardation of a retardation layer, substrate or plate which is defined with the following expression: Rₜₕ=[n_{z}−(nₓ+n_{y})/2]*d, where d is a thickness of the retardation layer, substrate or plate.

The term “in-plane retardation Rₒ” refers to a retardation of a retardation layer, substrate or plate which is defined with the following expression: Rₒ=(nₓ−n_{y})*d, where d is a thickness of the retardation layer, substrate or plate.

The above mentioned definitions are invariant to rotation of system of coordinates (of the laboratory frame) around of the vertical z-axis for all types of anisotropic layers.

The present invention also provides a polarizer as disclosed hereinabove. In one embodiment of a polarizer according to the present invention, the birefringent material is selected from the list comprising poly ethylene terephtalate (PET), poly ethylene naphtalate (PEN), polyvinyl chloride (PVC), polycarbonate (PC), oriented poly propylene (OPP), poly ethylene (PE), polyimide (PI), and poly ester.

In the Table 1 shown below, characteristics of different birefringent materials are presented in comparison with a TAC material:

TABLE 1

| Characteristics | | Material | | | | | | | |
|---|---|---|---|---|---|---|---|---|---|
| | Units | TAC | PET | PEN | PVC | PC | OPP | PE | PI |
| Density | g/cm² | 1.3 | 1.4 | 1.36 | 1.4 | 1.2 | 0.91 | 0.92 | 1.43 |
| Rupture | MPa | 118 | 230 | 280 | 98 | 98 | 186 | 20 | 280 |
| strength | | | | | | | | | |
| Rupture | % | 30 | 120 | 90 | 50 | 140 | 110 | 400 | 280 |
| elongation | | | | | | | | | |
| Water vapor | g/m²/24 hr | 700 | 21 | 6.7 | 35 | 60 | 8 | 20 | 64 |
| transmission | | | | | | | | | |
| rate | | | | | | | | | |
| Oxygen | cc/m²/hr/atm | 110 | 3 | 1 | 6 | 300 | 100 | 250 | 9.3 |
| transmission | | | | | | | | | |
| rate | | | | | | | | | |
| Water | % | 4.4 | 0.4 | 0.3 | 0.05 | 0.2 | 0.01 | 0.02 | 1.3 |
| absorbency | | | | | | | | | |
| Breakdown | kV | 3 | 6.5 | 7.5 | 4 | 6 | 6 | 4 | 7 |
| voltage | | | | | | | | | |
| Volume | Om * cm | 1015 | 1017 | 1017 | 1015 | 1017 | 1016 | 1017 | 1017 |
| resistivity | | | | | | | | | |
| Dielectric | — | 3.5 | 3.2 | 3 | 3 | 3 | 2.1 | 2.3 | 3.3 |
| constant | | | | | | | | | |
| Dielectric | — | 0.02 | 0.002 | 0.003 | 0.01 | 0.002 | 0.003 | 0.0005 | 0.001 |
| tangent | | | | | | | | | |
| Melting point | ° C. | 290 | 258 | 269 | 180 | 240 | 170 | 135 | — |
| Operating | ° C. | to 120 | −70 to | — | −20 | −100 | −50 | −50 to | — |
| temperature | | | 150 | | to 80 | to | to | 75 | |
| | | | | | | 130 | 120 | | |
| Organic solvent | — | bad | good | good | moderate | Moderate | good | good | good |
| tolerance | | | | | | | | | |
| Acid tolerance | — | bad | good | good | good | good | good | good | good |
| Alkari tolerance | — | bad | moderate | good | good | bad | good | good | bad |

As shown in the Table 1, PET material possesses much better mechanical properties, such as rupture strength and rupture elongation, than TAC—thus, substantially thinner film of PET can efficiently replace TAC film. PET is also several times less expensive than TAC. However PET film functions as a positive A-plate exhibiting high birefringence of Δn=0.01−0.05. Other birefringent materials shown in the Table 1, also demonstrate better mechanical properties, and higher environmental resistance which provide their advantage in comparison with a TAC material.

In another embodiment of the present invention, a polarizer comprises two substrates and a polarizing plate sandwiched between these substrates. In yet another embodiment of the present invention, a polarizer further comprises a retardation plate, wherein a type of the retardation plate is selected from the list comprising negative C-type, negative A-type, and B_{A}-type. In still another embodiment of a polarizer, the polarizing plate is based on a stretched polyvinyl alcohol (PVA).

In one embodiment of the disclosed polarizer both the retardation B_{A}-plate and negative A-plate comprise at least one organic compound of a first type, and at least one organic compound of a second type. The organic compound of the first type has the general structural formula I

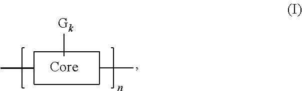

where Core is a conjugated organic unit capable of forming a rigid rod-like macromolecule, n is a number of the conjugated organic units in the rigid rod-like macromolecule, Gₖ is a set of ionogenic side-groups, and k is a number of the side-groups in the set Gₖ. The organic compound of the second type has the general structural formula II

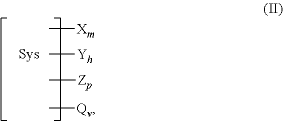

where Sys is an at least partially conjugated substantially planar polycyclic molecular system; X, Y, Z, Q and R are substituents; substituent X is a carboxylic group —COOH, m is 0, 1, 2, 3 or 4; substituent Y is a sulfonic group —SO₃H, h is 0, 1, 2, 3 or 4; substituent Z is a carboxamide —CONH₂, p is 0, 1, 2, 3 or 4; substituent Q is a sulfonamide —SO₂NH₂, v is 0, 1, 2, 3 or 4. The organic compound of the second type forms board-like supramolecules via π-π-interaction, and a composition comprising the compounds of the first and the second types forms lyotropic liquid crystal in a solution with suitable solvent. The solid retardation plate is formed from the solution, and the retardation plates are substantially transparent to electromagnetic radiation in the visible spectral range. The ionogenic side-groups and the number k provide solubility of the organic compound of the first type in a solvent and give rigidity to the rod-like macromolecule; the number n provides molecule anisotropy that promotes self-assembling of macromolecules in a solution of the organic compound or its salt. In another embodiment of the disclosed polarizer, the retardation negative C-plate comprises at least one organic polymer compound of the general structural formula III:

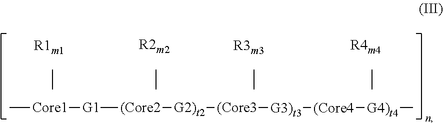

comprising n organic units, wherein the number n is an integer in the range from 5 to 1000, wherein the organic unit comprises conjugated organic components Core1, Core2, Core3 and Core4 capable of forming a rigid rod-like macromolecule, and where G1, G2, G3 and G4 are spacers selected from the list comprising —C(O)—NH—, —NH—C(O)—, —N═(C(O))2=, —O—NH—, linear and branched (C1-C4)alkylenes, linear and branched (C1-C4)alkenylenes, —O—CH2-, —CH2—O—, —CH═CH—, —CH═CH—C(O)O—, —O(O)C—CH═CH—, —C(O)—CH2-, —OC(O)O—, —OC(O)—, —C≡C—, —C(O)—S—, —S—, —S—C(O)—, —O—, —NH—, —N(CH3)-; R1, R2, R3 and R4 are lyophilic side-groups providing solubility to the organic polymer compound or its salts in a suitable solvent and which are the same or different and independently selected from the list comprising —COOM, —SO₃M, —HMPO₃ and -M₂PO₃ for water or water-miscible solvent where counterion M is selected from a list comprising H⁺, Na⁺, Li⁺, Cs⁺, Ba²⁺, Ca²⁺, Mg²⁺, Sr²⁺, Pb²⁺, Zn²⁺, La³⁺, Ce³⁺, Y³⁺, Yb³⁺, Gd³⁺, Zr⁴⁺ and NH₄₋ₖQₖ⁺, where Q is independently selected from the list comprising linear and branched (C1-C20) alkyl, (C2-C20) alkenyl, (C2-C20) alkinyl, and (C6-C20)arylalkyl, and k is 0, 1, 2, 3 or 4, and linear and branched (C1-C20) alkyl, (C2-C20) alkenyl, and (C2-C20) alkinyl for organic solvent; m1, m2, m3 and m4 are numbers of the lyophilic side-groups R1, R2, R3 and R4 in the conjugated organic components Core1, Core2, Core3 and Core4 accordingly which sum m=m1+m2+m3+m4 is equal to 0, 1, 2, 3, 4, 5, 6, 7, or 8; t2, t3 and t4 are numbers which are independently equal to 0 or 1, and wherein the solid optical retardation layer is a negative C-type or Ac-type plate substantially transparent to electromagnetic radiation in the visible spectral range.

The present invention also provides a liquid crystal display as disclosed hereinabove. In one embodiment of the disclosed liquid crystal display, a birefringent material of the substrate is selected from the list comprising poly ethylene terephtalate (PET), poly ethylene naphtalate (PEN), polyvinyl chloride (PVC), polycarbonate (PC), oriented poly propylene (OPP), poly ethylene (PE), polyimide (PI), and poly ester. In another embodiment of the disclosed liquid crystal display, at least one polarizer comprises two substrates and the polarizing plate sandwiched between the substrates.

In yet another embodiment of the disclosed liquid crystal display, at least one polarizer comprises a retardation plate, wherein type of the retardation plate is selected from the list comprising negative C-type, negative A-type, and B_{A}-type. In still another embodiment of the disclosed liquid crystal display, the liquid crystal cell is a vertical alignment mode liquid crystal cell and the front polarizer comprises a retardation plate of negative C-type. In one embodiment of the liquid crystal display, the liquid crystal cell is an in-plane switching mode liquid crystal cell and the front polarizer comprises a retardation plate of B_{A}-type or retardation plate of negative A-type. In another embodiment of the liquid crystal display, at least one polarizer comprises a polarizing plate based on a stretched polyvinyl alcohol (PVA).

In order that the invention may be more readily understood, reference is made to the following examples, which are intended to be illustrative of the invention, but are not intended to be limiting in scope.

### Example 1

This Example describes synthesis of poly(2,2′-disulfo-4,4′-benzidine terephthalamide) cesium salt which is an example of the organic compound of the structural formula III with SO₃M as lyophilic side-groups.

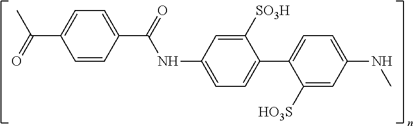

11.00 g (31.3 mmol) of 4,4′-diaminobiphenyl-2,2′-disulfonic acid was mixed with 31.31 g (95.6 mmol) of cesium carbonate, 0.60 g (15.7 mmol) of sodium borohydride and 297 ml of water, and stirred with dispersing stirrer until dissolved. While stirring the obtained solution at 10000 rpm the solution of 7.12 g (34.9 mmol) of Terephthaloyl Dichloride and 0.21 g (1.5 mmol) of Benzoyl Dichloride in dry Toluene (595 mL) were gradually added within 5 min. The stirring was continued for 5 more min, and viscous white emulsion formed. Reaction was stopped by adding of 4.42 ml of benzoyl chloride in 50 ml of toluene and following stirring for another 3 min. Then the emulsion was diluted with 600 ml of acetone and stirred for another 3 min. The emulsion was allowed to stand until separation occurred and water layer got separated. The polymer was precipitated with 3330 ml of ethanol, dissolved in 590 ml of water and precipitated again with 2360 ml of acetone. The sediment was filtered and dried.

Gel permeation chromatography (GPC) analysis of the sample was performed with Hewlett Packard 1050 chromatograph with diode array detector (λ=230 nm), using Varian GPC software Cirrus 3.2 and Shodex Asahipak 6F-7M HQ column; mixture of acetonitrile and 0.05M phosphate buffer (pH=7) taken in the ratio 40/60, respectively, as the mobile phase. Poly(para-styrenesulfonic acid) sodium salt was used as a GPC standard. The number average molecular weight Mn, weight average molecular weight Mw, and polydispersity P were found as 6.2×10⁵, 1.2×10⁶, and 2.0 respectively.

### Example 2

This Example describes synthesis of poly(2,2′-disulfo-4,4′-benzidine isophthalamide) cesium salt which is an example of the organic compound of the structural formula III with SO₃M as lyophilic side-groups.

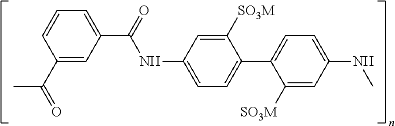

1.377 g (0.004 mol) of 4,4′-diaminobiphenyl-2,2′-disulfonic acid was mixed with 1.2 g (0.008 mol) of CsOH monohydrate and 40 ml of water and stirred with a dispersing stirrer until dissolving. 0.672 g (0.008 mol) of sodium bicarbonate was added to the solution and stirred. While stirring the solution at a high speed (2500 rpm) a solution of 0.812 g (0.004 mol) of isophthaloyl dichloride in dried toluene (15 mL) was gradually added within 5 minutes. The stirring was continued for 5 more minutes, and viscous white emulsion was formed. Then the emulsion was diluted with 40 ml of water, and the stirring speed was reduced to 100 rpm. After the reaction mass has been homogenized the polymer was precipitated by adding 250 ml of acetone. Fibrous sediment was filtered and dried.

Molar mass of the polymer samples was determined by a gel permeation chromatography (GPC). The GPC analysis of the polymer samples was performed with Hewlett Packard 1050 HPLC system and with a diode array detector (λ=230 nm). The chromatographic separation was done using the TSK gel G5000 PW_{XL} column from TOSOH Bioscience. Phosphate buffer 0.2 M (pH=6.9-7.0) was used as a mobile phase. Chromatographic data were collected and processed using the ChemStation B10.03 (Agilent Technologies) and GPC software Cirrus 3.2 (Varian). Poly(para-styrenesulfonic acid) sodium salt was used as a GPC standard.

### Example 3

Example 3 describes synthesis of 2,2′-disulfo-4,4′-benzidine terephthalamide-isophthalamide copolymer cesium salt.

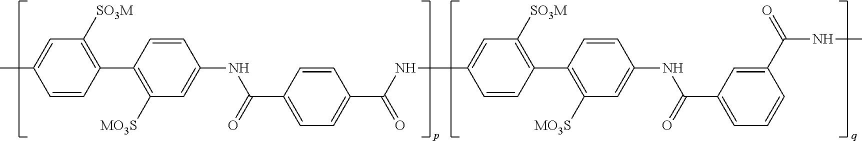

The same or similar method of synthesis can be used for preparation of the copolymers of different molar ratio.

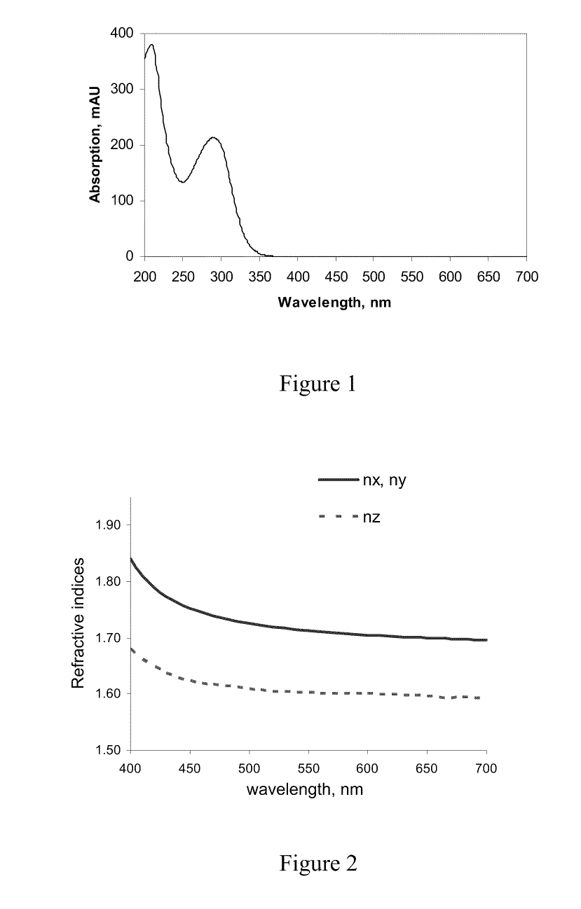

39.69 g (114 mmol) 4,4′-diaminobiphenyl-2,2′-disulfonic acid was mixed with 25.68 g (238 mmol) of sodium carbonate and 2.19 g (57 mmol) of sodium borohydride in water (218 ml) in a 3 L beaker and stirred until the solid was completely dissolved. Then toluene (218 ml) was added. Upon stirring the obtained solution at 10000 rpm, a solution of 16.9 g (83 mmol) of terephthaloyl chloride (TPC), 6.32 g (31 mmol) of isophthaloyl chloride (IPC) and 2.59 g (18 mmol) of benzoyl chloride in toluene (109 ml) were added. The resulting mixture was stirred for 3 min, and then 14.2 g (100 mmol) of benzoyl chloride and 220 ml of acetone were added. The resulting emulsion was transferred to a separation funnel, and aqueous layer was isolated. The polymer was precipitated by adding of 1640 ml of acetone, the suspension was filtered, and the filter cake washed with 2200 ml of ethanol and 1100 ml of acetone. The obtained polymer was dried at 80° C. The material was characterized with absorbance spectrum presented in FIG. 1. The GPC molecular weight analysis of the sample was performed as described in Examples 1 and 2.

### Example 4

This Example describes synthesis of natrium salt of the polymer poly(sulfo-phenylethylen) which is an example of the organic compound of the structural formula I.

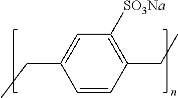

0.654 g of copper (II) chloride (4.82 mmol, 0.07 eq) was dissolved into 410.0 ml (had been degassed by evacuated and filled with argon and then purging with argon) of water with stirring at ambient condition in 2500-ml beaker. 26.0 g of 2,5-bis-(bromomethyl)-benzenesulfonic acid (66.02 mmol) was added to the obtained solution and then 25.82 g of sodium bromide (250.88 mmol, 3.8 eq) was added into a whitish suspension. 115.5 ml of n-amyl alcohol was added to reaction mixture with a simultaneous vigorous stirring. 10.03 g of sodium borohydride (264.08 mmol, 4.0 eq) in 52.0 ml of water was added in one portion to a reaction mixture at a simultaneous vigorous stirring. The resulting mixture was stirred for 10 min. The bottom water layer was isolated and the resulted dark cloudy solution was filtered through a double layer glass filter paper (D=185 mm). The resulting solution was filtered through a filter-membrane (Millipore, PHWP29325, mixed cellulose ester, 0.3 mkm) using Stirred Ultrafiltration Cell. Water was evaporated and 24.1 g of dry polymer was obtained. (Mn=20536, Mw=130480, Pd=6.3).

### Example 5

This Example describes synthesis of natrium salt of the polymer Poly((1,4-dimethylen-2-sulfophenyl)-(4,4′-dioxi-1,1′-disulfobiphenyl)ether) which is an example of the organic compound of the structural formula I.

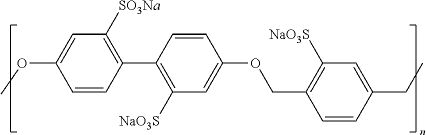

556 mg of 2,5-bis(bromomethyl)benzenesulfonic acid, 557 mg of 4,4′-dihydroxybiphenyl-2,2′-disulfonic acid and 500 mg of tetra-n-butylammonium bromide were dissolved in 10 ml of abs. N-methylpyrrolidone. 332 mg of 60% sodium hydride (5.1 eq.) was added by small portions to this solution, and the mixture was stirred for 4 days at 50° C. After that the mixture was poured into 100 ml of ethanol and filtered off. The precipitate was dissolved in water (˜5 ml) and precipitated into 100 ml of ethanol and filtered off again. 340 mg of polymer with Mn=9K, Mw=15K was obtained.

### Example 6

This Example describes synthesis of natrium salt of the polymer Poly((4,4′-dimethylen-1,1′-disulfobiphenyl)-(4,4′-dioxi-1,1′-disulfobiphenyl)ether) which is an example of the organic compound of the structural formula I.

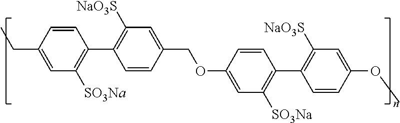

400 mg of 4,4′-bis(chloromethyl)biphenyl-2,2′-disulfonic acid, 337 mg of 4,4′-dihydroxybiphenyl-2,2′-disulfonic acid and 400 mg of tetra-n-butylammonium bromide were dissolved in 10 ml of abs. N-methylpyrrolidone. 238 mg of 60% sodium hydride (6.1 eq.) was added by small portions to this solution, and the mixture was stirred for 4 days at 50° C. After that the mixture was poured into 100 ml of ethanol and filtered off. The precipitate was dissolved in water (˜5 ml) and precipitated into 100 ml of ethanol and filtered off again. 330 mg of polymer with Mn=3K, Mw=5K was obtained.

Synthesis of a Monomer for this Polymer was Done as Follows:

### Intermediate 1:

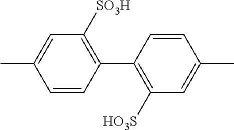

2-iodo-5-methylbenzenesulfonic acid (46 g, 137 mmol) was placed into a two-neck flask (volume 500 mL) and water (200 mL) was added. Blue copperas copper sulfate (0.25 g, 1 mmol) in water (40 mL) was added to a resultant solution, and the resulting mixture was heated to 85° C. for 15 min. Copper powder was added (14. g, 227 mmol) to a dark solution. Temperature elevated to 90° C., and then a reaction mixture was stirred for 3 h at 80-85°. Reaction mixture was filtered twice, solution was concentrated to 75 mL on a rotary evaporator, cooled to 0° C. and ethanol was added dropwise (25 mL). The formed precipitate was filtered off and washed with ethanol and dried at 50° C. Yield 28 g.

### Intermediate 2:

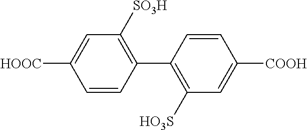

4,4′-dimethylbiphenyl-2,2′-disulfonic acid (30.0 g, 71.7 mmol) was dissolved in water (600 mL), and sodium hydroxide was added (12 g, 300 mmol). A resultant solution was heated to 45-50° C. and potassium permanganate was added (72 g, 45 mmol) in portions for 1 h 30 min. Resultant mixture was stirred for 16 h at 50-54° C. and then cooled to 40° C., methanol was added (5 mL), temperature elevated to 70° C. Mixture was cooled to 40° C., filtered from manganese oxide, clear colorless solution was concentrated to 100 mL acidified with hydrochloric acid (50 mL). Resultant mixture was left overnight, cooled to 0° C. and filtered off, washed with acetonitrile (100 mL, re-suspension) and diethylether, and dried. 13.5 g of a fibrous white solid was obtained.

### Intermediate 3:

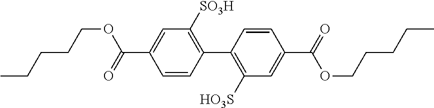

2,2′-disulfobiphenyl-4,4′-dicarboxylic acid (7.5 g, 18.6 mmol) was mixed with n-pentanol (85 mL, 68 g, 772 mmol) and sulfuric acid (0.5 mL) and heated under reflux with Dean-Stark trap for additional 3 hours. Reaction mixture was cooled to 50° C., diluted with hexane (150 mL), stirred at the same temperature for 10 min, precipitate was filtered off and washed with hexane (3×50 mL), and then dried at 50° C. for 4 h. Yield: weight 8.56 g (84%), white solid.

### Intermediate 4:

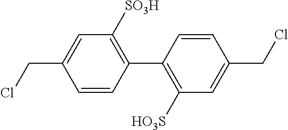

Anhydrous tetrahydrofuran (400 mL) was placed into a flask supplied with a condenser, magnetic stirrer, thermometer and argon T-tube. Lithium alumohydride (3.5 g, 92 mmol) was added to tetrahydrofuran, resultant suspension was heated to 50° C. and 4,4′-bis[(pentyloxy)carbonyl]biphenyl-2,2′-disulfonic acid was added in portions for 10 min with an efficient stirring (20.0 g, 37 mmol). Resultant suspension was mildly boiled under reflux (63-64° C.) for 1.5 h.

Reaction mixture was cooled to a 10°-temperature (ice-water), and water was added with stirring until hydrogen evolution ceased (5-5.2 mL). Then mixture was diluted with anhydrous tetrahydrofuran (100 mL) to make stirring efficient. Resultant white suspension was transferred to a flask of 1 L volume, and acidified with a hydrochloric acid 36% (24 g). Sticky precipitate was formed and was well-stirred with a glass rod. The mixture was dried on a rotary evaporator, residue was mixed with anhydrous tetrahydrofuran (100 mL), solvent was removed on a rotary evaporator, and white solid residue was dried in a drying pistol at 67° C./10 mm Hg (boiling methanol) for 2 h. White pieces were powdered and dried for additional 1 hour.

Resultant weight was 30 g, a white powder. Calculated product content is approximately 1.25 mmol/g (50%) of diol in the mixture of inorganic salts (AlCl₃, LiCl) and solvating water.

Crude 4,4′-bis(hydroxymethyl)biphenyl-2,2′-disulfonic acid (3.0 g, 3 mmol) was mixed with hydrochloric acid 36% (10 mL) and stirred at a bath temperature of 85° C. for 1.5 h. Gas hydrogen chloride was passed though reaction mixture twice for 10 minutes after 15 minutes and 1 h 20 minutes of heating. Clear solution was not formed but an almost clear suspension was observed. Reaction mixture was cooled to 0° with an ice-water bath, stirred under a flow of hydrochloric acid at the same temperature, and white precipitate was filtered off and dried over potassium hydroxide overnight in vacuo. Weight 2.6 g.

### Example 7

This Example describes synthesis of natrium salt of the polymer Poly((4,4′-dimethylen-1-sulfobiphenyl)-(4,4′-dioxi-1,1′-disulfobiphenyl)ether) which is an example of the organic compound of the structural formula I.

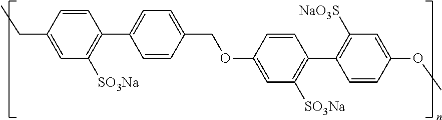

100 mg of 4,4′-bis(bromomethyl)biphenyl-2-sulfonic acid, 83 mg of 4,4′-dihydroxybiphenyl-2,2′-disulfonic acid and 80 mg of tetra-n-butylammonium bromide were dissolved in 2 ml of abs. N-methylpyrrolidone. 50 mg of 60% sodium hydride (5.1 eq.) was added by small portions to this solution, and the mixture was stirred for 4 days at 50° C. After that the mixture was poured into 20 ml of ethanol and filtered off. The precipitate was dissolved in water (˜2-3 ml) and precipitated into 50 ml of ethanol and filtered off again. 100 mg of polymer with Mn=10K, Mw=23K was obtained.

Synthesis of Monomer for this Polymer was Done as Follows:

### Intermediate 5:

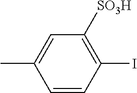

2-Sulfo-p-toluidine (50 g, 267 mmol) was mixed with water (100 mL) and hydrochloric acid 36% (100 mL). The mixture was stirred and cooled to 0° C. A solution of sodium nitrite (20 g, 289 mmol) in water (50 mL) was added slowly (dropping funnel, 1.25 h) with keeping temperature at 3-5° C. Then a resultant suspension was stirred for 1 h 45 min at 0-3° C., filtration produced a dark wet mass which was added in portions into a tall beaker supplied with a magnetic stirrer and thermometer containing potassium iodide (66.5 g, 400 mmol) dissolved in 25% sulfuric acid (212 mL); temperature was kept around 10° C. A lot of nitrogen evolved, foaming, a large magnetic bar is required. Then a reaction mixture was warmed to a room temperature, and 25% solution of sulfuric acid (200 mL) was added. Heating was continued at 70° C. for 30 min and 25% solution of sulfuric acid (150 mL) was added and stirred for a while. Mixture was hot filtered from black insoluble solids, cooled to a room temperature with simultaneous stirring. A precipitate was formed, solution was dark. Precipitate was filtered on a Pall glass sheet, washed with ethanol-water 1:1 (100 mL), re-suspended (ethanol 100 mL) and filtered once again, washed on the filter with ethanol (50 mL) and dried in a stove at 50° C.; a resultant compound is pale-brown. Yield was 46 g (57%).

### Intermediate 6:

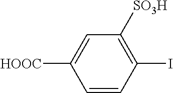

Water (500 mL) was poured into a one-neck flask (volume 1 L) followed by sodium hydroxide (6.5 g, 160 mmol) and 3-sulfo-4-iodotoluene (20.0 g, 67.1 mmol). Resultant solution was warmed up to 40° C. and a finely powdered potassium permanganate (31.8 g, 201 mmol) was introduced in small portions at intervals of 10 min into a well stirred liquid. Adding was carried out for 1 h 30 min. Temperature was kept at 40-45° C. (bath) during adding. Then a reaction mixture was heated up to 75-80° C. (bath) and left for 16 h at this temperature. A mixture of methanol-water 1:1 (5.5 mL) was added at 60° C., dark suspension was cooled to 35-40° C. and filtered off. Clear transparent solution was acidified with hydrochloric acid 36% (130 mL) and concentrated on a rotary evaporator distilling approx. ⅓ of the solvent. White precipitate was formed. Suspension was cooled on ice, filtered off, washed with acetonitrile (50 mL) and diethylether (50 mL). White solid was dried in a stove at 50° C. until smell of hydrochloric acid disappeared (4 h). Weight 22 g.

### Intermediate 7:

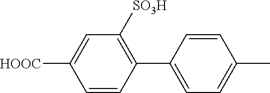

Water (550 mL) was placed into a flask equipped with thermometer, magnetic stirrer, argon inlet tube and bubble counter, heated to 40° C., potassium carbonate was added (40.2 g, 291 mmol), followed by 4-iodo-3-sulfobenzoic acid (19.1 g, 58.3 mmol) and 4-methylphenylboronic acid (8.33 g, 61.2 mmol). Solution was formed. Apparatus was evacuated and filled with argon 4 times with stirring. Pd/C 10% (Aldrich, 1.54 mg, 1.46 mmol) was added and apparatus was flashed with argon 3 times more. Temperature of solution elevated to 75-80° and a resultant mixture (transparent except for C) was stirred for 16 h under argon atmosphere. Reaction mixture was cooled to 40° C., filtered twice (PALL), hydrochloric acid 36% was added drop wise (ice bath) until CO₂ evolution seized and a little bit more (55 g). A resultant suspension was cooled on ice, filtered off, washed in a beaker with acetonitrile (50 ml), filtered and washed with diethylether (50 mL) on the filter, then dried in a stove for 3 h at 45° C. Yield 10.0 g (58%).

### Intermediate 8:

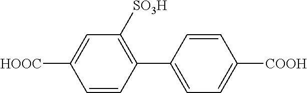

Water was placed (500 mL) into a two-neck flask (volume 1 L) followed by sodium hydroxide (4.4 g, 109 mmol) and 4′-methyl-2-sulfobiphenyl-4-carboxylic acid (10.0 g, 34.2 mmol). Resultant solution was warmed up to 40° C. (oil bath, inside temperature), and a finely powdered potassium permanganate (16.2 g, 102.6 mmol) was introduced in small portions at intervals of 10 min into a well stirred liquid. Adding step was carried out for 45 min. Temperature was kept at 40-45° C. (bath) during adding. Then a reaction mixture was heated up to 50° C. (inner) and left for 18 h at the same temperature with stirring. A mixture of methanol-water 1:1 (2 mL) was added at 45° C., dark suspension was cooled to r.t. and filtered off. Clear transparent solution was acidified with hydrochloric acid 36% (13 g). White precipitate was formed. Suspension was cooled on ice, filtered off, washed with acetonitrile (50 mL) in a beaker, filtered and washed with diethylether (50 mL) on the filter. White solid was dried in a stove at 50° C. until smell of hydrochloric acid disappeared (4 h). Weight 7.5 g (68%)

### Intermediate 9:

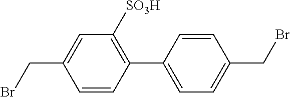

Powdered 2-sulfobiphenyl-4,4′-dicarboxylic acid (7.5 g, 23.3 mmol) was mixed with anhydrous (dist. over magnesium) methanol (100 mL) and sulfuric acid (d 1.84, 2.22 mL, 4.0 g, 42.6 mmol). A resultant suspension was left with stirring and mild boiling for 2 days. Sodium carbonate (5.01 g, 47.7 mmol) was added to methanol solution and stirred for 45 min then evaporated on a rotary evaportator. Residue (white powder) was mixed with tetrahydrofuran to remove any big particles (100 mL) and resultant suspension was dried on a rotary evaporator and then in a dessicator over phosphorus oxide under a reduced pressure overnight. Resultant residue was used for further steps.

A one-neck flask (volume 250 mL) containing dried crude 4,4′-bis(methoxycarbonyl)biphenyl-2-sulfonic acid and a magnetic stirrer and closed with a stopper was filled with tetrahydrofuran (anhydrous over sodium, 150 mL). White suspension was stirred for 20 min at a room temperature to insure its smoothness, and then lithium alumohydride was added in portions (0.2-0.3 g) for 40 min. Exothermic effect was observed. Temperature elevated to 45-50° C. Then joints were cleaned with soft tissue and flask was equipped with condenser and argon bubble T-counter. Resultant suspension was heated with stirring (bath 74° C.) for 3 h.

Reaction mixture was cooled to 10° C. on ice, and water was added drop wise until hydrogen evolution (COUTION!) seized (4 mL). Hydrobromic acid (48%) was added in small portions until suspension became milky (43 g, acid reaction of indicator paper). The suspension was transferred to flask of 0.5 L volume and it was taken to almost to dryness on a rotary evaporator. Hydrobromic acid 48% was added to the flask (160 mL), resultant muddy solution was filtered (PALL) and flask was equipped with h-tube with a thermometer and argon inlet tube. Apparatus was flashed with argon and placed on an oil bath. Stirring was carried out while temperature (inner) elevated to 75° C. for 15 min. After 7 minutes at this temperature a formation of white precipitate was observed. Stirring was carried out for 1.5 h at 70-75° C., then suspension was cooled to 30° C., filtered off, precipitate was washed with cold hydrobromic acid 48% (30 mL) on the filter and slightly pressed. Filter cake was dried over sodium hydroxide in a dessicator under a reduced pressure and with a simultaneous periodical filling it with argon. Weight 7.0 g (72% on diacid).

### Example 8

This Example describes synthesis of 7-(4-sulfophenyl)dibenzo[b,d]thiophene-3-sulfonic acid 5,5-dioxide which is an example of the organic compound of the structural formula II.

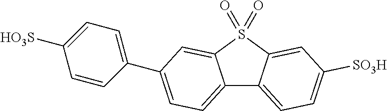

7.83 g of p-Terphenyl was dissolved in 55 ml of 10% oleum at 10-20° C., and the mixture was stirred for 20 hrs at an ambient temperature. 20 g of ice was added to the formed suspension and the mixture was cooled to 0° C. The solid was filtered and washed with 36% hydrochloric acid, dissolved in a minimal amount of water (the solution was filtered from impurities) and precipitated with 36% hydrochloric acid. The product was filtered, washed with 36% hydrochloric acid and dried. 9.23 g was obtained.

### Example 9

This Example describes preparation of a solid optical retardation layer of a negative C-type from a solution of poly(2,2′-disulfo-4,4′-benzidine isophthalamide). 2 g of poly(2,2′-disulfo-4,4′-benzidine isophthalamide) cesium salt was produced as described in Example 2, dissolved in 100 g of de-ionized water (conductivity ˜5 μSm/cm), and the suspension was mixed with a magnet stirrer. After dissolving, the solution was filtered with the hydrophilic filter of a 45 μm pore size and evaporated to the viscous isotropic solution of concentration of solids of about 6%.

Fisher brand microscope glass slides were prepared by soaking in a 10% NaOH solution for 30 min, rinsing with deionized water, and drying in airflow with the compressor. At temperature of 22° C. and relative humidity of 55% the obtained LLC solution was applied onto the glass panel surface with a Gardner® wired stainless steel rod #14, which was moved at a linear velocity of about 10 mm/s. The optical film was dried with a flow of the compressed air.

In order to determine optical characteristics of the solid optical retardation layer, transmission and reflection spectra were measured in a wavelength range from 400 to 700 nm using Cary 500 Scan spectrophotometer. Optical transmission and reflection of the retardation layer was measured using light beams linearly polarized parallel and perpendicular to the coating direction (Tₚₐᵣ and Tₚₑᵣ, respectively). The obtained data were used for calculation of the in-plane refractive indices (nₓ and n_{y,}). Optical retardation spectra at different incident angles were measured in a wavelength range from 400 to 700 nm using Axometrics Axoscan Mueller Matrix spectropolarimeter, and out-of-plane refractive index (n_{z}) was calculated using these data and the results of the physical thickness measurements using Dectak³ST electromechanical profilometer. The obtained solid optical retardation layer had thickness of approximately 750 nm and principle refractive indices which obey the following condition: n_{z}<n_{y}≈nₓ. Out-of-plane birefringence equals to 0.09.

### Example 10

Example 6 describes preparation of a solid optical retardation layer of a negative C-type with 2,2′-disulfo-4,4′-benzidine terephthalamide-isophthalamide copolymer (terephthalamide/isophthalamide molar ratio 50:50) prepared as described in Example 3.

2 g of poly(2,2′-disulfo-4,4′-benzidine terephthalamide-isophthalamide copolymer) cesium salt was produced as described in Example 3, dissolved in 100 g of de-ionized water (conductivity ˜5 μm/cm). The suspension was mixed with a magnet stirrer. After dissolving, the solution was filtered with the hydrophilic filter of a 45 μm-pore size and evaporated to the viscous isotropic solution of the concentration of solids of about 6%.

Fisher brand microscope glass slides were prepared for coating by soaking in a 10% NaOH solution for 30 min, rinsing with deionized water, and drying in airflow with the compressor. At temperature of 22° C. and relative humidity of 55% the obtained LLC solution was applied onto the glass panel surface with a Gardner® wired stainless steel rod #14, which was moved at a linear velocity of about 10 mm/s. The optical film was dried with a flow of the compressed air. The drying was not accompanied with any thermal treatment, and it took around several minutes.

In order to determine the optical characteristics of the solid optical retardation layer, transmission and reflection spectra were measured in a wavelength range from 400 to 700 nm using Cary 500 Scan spectrophotometer. Optical transmission and reflection of the retardation layer were measured using light beams linearly polarized parallel and perpendicular to the coating direction (Tₚₐᵣ and Tₚₑᵣ, respectively). The obtained data were used for calculation of the in-plane refractive indices (nₓ and n_{y,}). Optical retardation spectra at different incident angles were measured in a wavelength range from 400 to 700 nm using Axometrics Axoscan Mueller Matrix spectropolarimeter, and out-of-plane refractive index (n_{z}) was calculated using these data and the results of the physical thickness measurements using Dectak³ST electromechanical profilometer. The refractive indices spectral dependences are presented in FIG. 2. The obtained solid optical retardation layer is characterized by thickness equal to approximately 800 nm and the principle refractive indices which obey the following condition: n_{z}<n_{y}≈n_{x,}. Out-of-plane birefringence equals to 0.11.

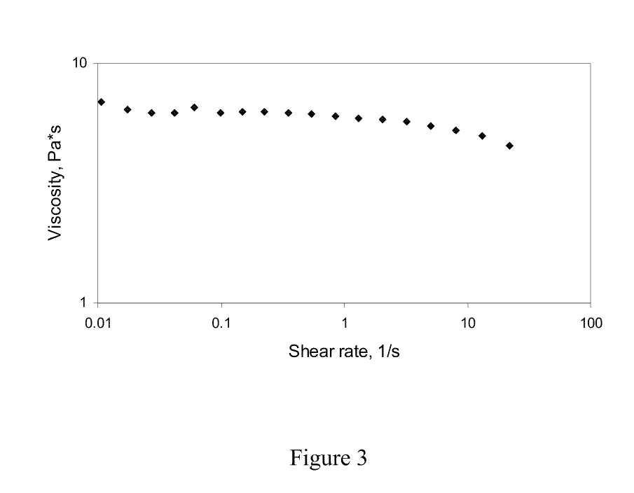

FIG. 3 shows the viscosity vs. shear rate dependence of the solution measured using stress-controlled AR 550 rheometer. The measurements were performed at 25° C. The cone-and-plate geometry (cone diameter=60 mm, gap=2°) was used.

### Example 11

This Example describes synthesis of poly(2,2′-disulfo-4,4′-benzidine sulfoterephthalamide) which is an example of the organic compound of the structural formula I with SO₃H as ionogenic side-groups Gₖ:

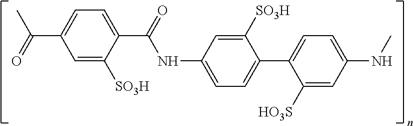

10 g (40 mmol) of 2-sulfoterephtalic acid, 27.5 g (88.7 mmol) of triphenylphosphine, 20 g of lithium chloride and 50 ml of pyridine were dissolved in 200 ml of N-methylpyrrolidone in a 500 ml three-necked flask. The mixture was stirred at 40° C. for 15 min and then 13.77 g (40 mmol) of 4,4′-diaminobiphenyl-2,2′-disulfonic acid were added. The reaction mixture was stirred at 115° C. for 3 hours. 1 L of methanol was added to the viscous solution, a formed yellow precipitate was filtrated and washed sequentially with methanol (500 ml) and diethyl ether (500 ml). Yellowish solid was dried in vacuo at 80° C. overnight.

### Example 12

This Example describes synthesis of 4,4′-(5,5-dioxidodibenzo[b,d]thiene-3,7-diyl)dibenzenesulfonic acid which is an example of the organic compound of the structural formula II.

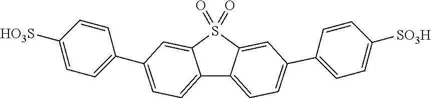

1,1′:4′,″: 4″,1′″-quarerphenyl (10 g) was charged into 0%-20% oleum (100 ml). Reaction mass was agitated for 5 hours at heating to 50° C. After that the reaction mixture was diluted with water (170 ml). The final sulfuric acid concentration was approximately 55%. The precipitate was filtered and rinsed with glacial acetic acid (˜200 ml). The filter cake was dried in an oven at 110° C.

HPLC analysis of the sample was performed with Hewlett Packard 1050 chromatograph with a diode array detector (λ=310 nm), using Reprosil™ Gold C8 column and linear gradient elution with acetonitrile/0.4 M ammonium acetate (pH=3.5 acetic acid) aqueous solution.

### Example 13

This Example describes preparation of a solid optical retardation layer of B_{A}-type from a solution comprising a binary composition of poly(2,2′-disulfo-4,4′-benzidine sulfoterephthalamide) described in Example 11 and denoted below as P2 and 4,4′-(5,5-dioxidodibenzo[b,d]thiene-3,7-diyl)dibenzenesulfonic acid described in Example 12 and denoted below as C1.

The P2/C1=35/65 molar % composition was prepared as follows: 2.86 g (0.0035 mol) of the cesium salt of P2 was dissolved in 70 g of de-ionized water (conductivity ˜5 μSm/cm), and the suspension was mixed with a magnet stirrer. After dissolving, the solution was filtered at the hydrophilic nylon filter with pore size 45 μm. Separately, 3.44 g (0.0065 mol) of C1 was dissolved in 103 g of de-ionized water, and suspension was mixed with a magnet stirrer. While stirring, 7.75 ml of 20 wt. % cesium hydroxide was gradually added drop-by-drop into the suspension for approximately 15 minutes until a clear solution was formed. Clear solutions of P2 and C1 were mixed together to form 400 g of a clear solution. This composition was concentrated on a rotary evaporator in order to remove an excess of water and form 70 g of a binary composition representing a lyotropic liquid crystal (LLC) solution. The total concentration of composition (P2+C1) C_{TOT} was equal to about 11%. The coatings were produced and optically characterized, as was described in Example 11, however, Gardner® wired stainless steel rod #4 was used instead of Gardner® wired stainless steel rod #8. The obtained solid optical retardation layer was characterized by principle refractive indices, which obey the following condition: nₓ<n_{z}<n_{y}. The NZ-factor at wavelength λ=550 nm is equal to about 0.7.

### Example 14

This example describes one preferred embodiment of the liquid crystal display according to the present invention.

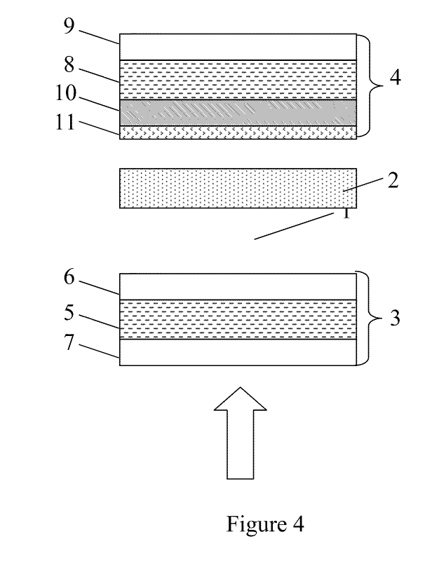

FIG. 4 schematically shows a light beam (1) and a liquid crystal display which comprises a liquid crystal cell (2) of a vertical alignment mode, rear and front polarizers (3 and 4) arranged on each side of the liquid crystal cell. The liquid crystal cell has thickness retardation Rₜₕ, which equals to approximately 300 nm. Transmission axis of the front polarizer is perpendicular to the transmission axis of the rear polarizer.

The rear polarizer (3) comprises a polarizing plate (5) based on a stretched polyvinyl alcohol (PVA) and located between two substrates (6 and 7) made of a triacetyl cellulose (TAC). The substrates (6) and (7) are characterized by thickness d=50 μm, thickness retardation Rₜₕ=−50 nm and in-plane retardation Ro=0 nm.

The front polarizer (4) comprises a polarizing plate (8) based on a stretched polyvinyl alcohol (PVA) and which is placed between two substrates (9 and 10). The substrate (9) made of a triacetyl cellulose (TAC) is characterized by thickness d=50 μm, thickness retardation Rₜₕ=−50 nm and in-plane retardation R^{o}=0 nm. The substrate (10) is made of an oriented polypropylene (OPP) and is characterized by thickness d=15 μm, thickness retardation Rₜₕ=−72 nm and in-plane retardation R^{o}=144 nm. The substrate (10) is a compensating layer of positive A-type and its slow optical axis (highest principal refractive index) is perpendicular to the absorption axis of front PVA polarizer. A compensating coating layer (11) of negative C-type is positioned between the substrate (10) and the liquid crystal cell (2), and it is characterized by thickness d=1.4 μm and thickness retardation Rₜₕ=−168 nm.

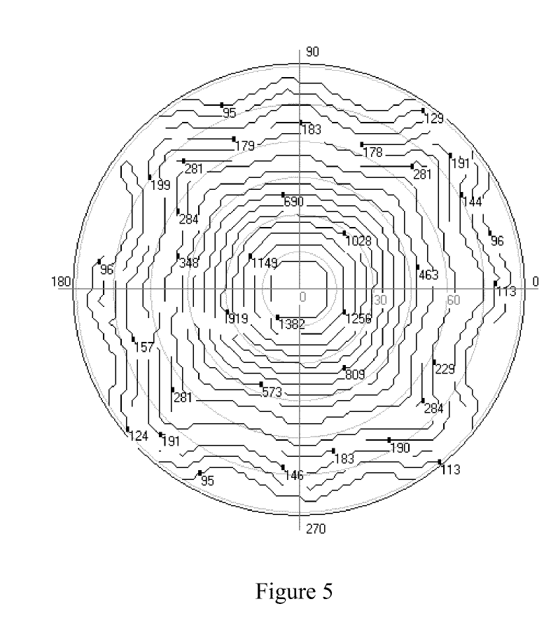

The calculated viewing angle performance of such design is illustrated in FIG. 5.

### Example 15

This Example describes one preferred embodiment of the liquid crystal display according to the present invention.

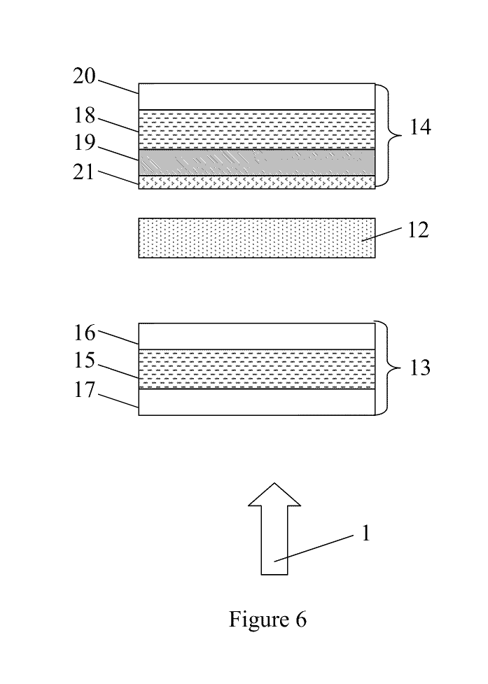

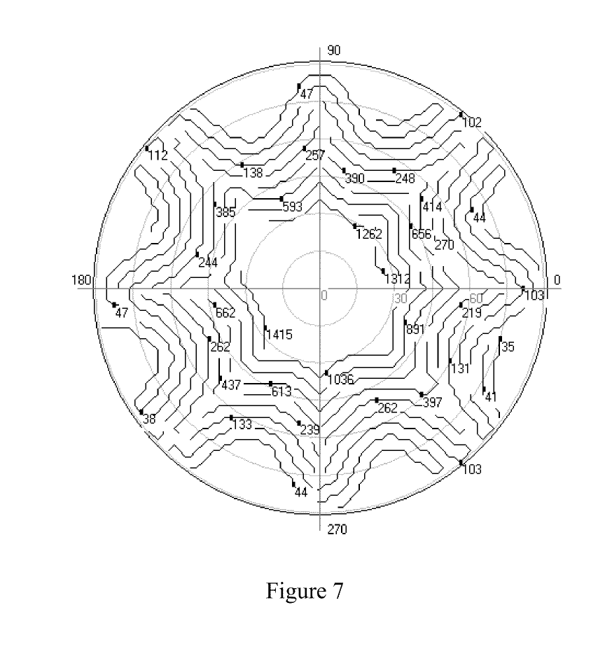

FIG. 6 schematically shows a light beam (1) and a liquid crystal display which comprises a liquid crystal cell (12) of an in-plane switching mode, rear and front polarizers (13 and 14) arranged on each side of the liquid crystal cell. The liquid crystal cell has an in-plane retardation R^{o}, which equals to −275 nm. The transmission axis of the front polarizer is perpendicular to the transmission axis of the rear polarizer.

The rear polarizer (13) comprises a polarizing plate (15) based on a stretched polyvinyl alcohol (PVA) and located between two substrates (16 and 17) made of triacetate cellulose (TAC). The substrates (16) and (17) are characterized by thickness d=50 μm, thickness retardation Rₜₕ=−50 nm and in-plane retardation Ro=0 nm.

The front polarizer (14) comprises a polarizing plate (18) based on a stretched polyvinyl alcohol (PVA) and placed between two substrates (19 and 20). The substrate (19) made of a triacetyl cellulose (TAC) is characterized by thickness d=50 μm, thickness retardation Rₜₕ=−50 nm and in-plane retardation R^{o}=0 nm. The substrate (20) is made of an oriented polypropylene (OPP) and is characterized by thickness d=45 μm, thickness retardation Rₜₕ=−225 nm and in-plane retardation R^{o}=450 nm. The substrate (20) is a compensating layer of positive A-type and its slow optical axis (highest principal refractive index) is perpendicular to the absorption axis of a front PVA polarizer. A compensating coating layer (21) of biaxial B_{A}-type is positioned between the substrate (20) and the liquid crystal cell (12), and it characterized by thickness d=1 μm, thickness retardation Rₜₕ=100 nm and in-plane retardation R^{o}=200 nm; and its fast optical axis (lowest principal refractive index) is perpendicular to the absorption axis of front PVA polarizer. The calculated viewing angle performance of such design is illustrated in FIG. 7.

Those skilled in the art will appreciate that various other modifications may be made within the spirit and scope of the invention. All these or other variations and modifications are contemplated by the inventors and within the scope of the invention.

What is claimed is:

1. A polarizer comprising
at least one substrate made of a birefringent material, and
a polarizing plate located on the substrate,
wherein the substrate possesses an anisotropic property of positive A-type and has a slow optical axis parallel to the substrate surface,
wherein the polarizing plate possesses anisotropic absorption of the electromagnetic radiation in at least one subrange of the visible spectral range, and
wherein a transmission axis of the polarizing plate and the slow optical axis of the substrate are substantially parallel to each other.

2. A polarizer according to claim 1, wherein the birefringent material is selected from the list comprising poly ethylene terephtalate (PET), poly ethylene naphtalate (PEN), polyvinyl chloride (PVC), polycarbonate (PC), oriented poly propylene (OPP), poly ethylene (PE), polyimide (PI), and poly ester.

3. A polarizer according to claim 1, comprising two said substrates, wherein the polarizing plate is sandwiched between the substrates.

4. A polarizer according to claim 1, further comprising a retardation plate, wherein type of the retardation plate is selected from the list comprising negative C type, negative A type, and B_{A} type.

5. A polarizer according to claim 1, wherein the polarizing plate is made of a stretched polyvinyl alcohol (PVA).

6. A polarizer according to any of claim 4 or 5, wherein the retardation B_{A}-plate and negative A-plate comprise at least one organic compound of a first type, and at least one organic compound of a second type, wherein the organic compound of the first type has the general structural formula I 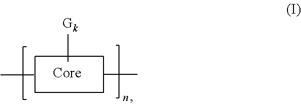
where Core is a conjugated organic unit capable of forming a rigid rod-like macromolecule, n is a number of the conjugated organic units in the rigid rod-like macromolecule, Gₖ is a set of ionogenic side-groups, and k is a number of the side-groups in the set Gₖ; and wherein the organic compound of the second type has the general structural formula II 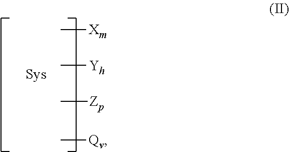
where Sys is an at least partially conjugated substantially planar polycyclic molecular system; X, Y, Z, Q and R are substituents; substituent X is a carboxylic group —COOH, m is 0, 1, 2, 3 or 4; substituent Y is a sulfonic group —SO₃H, h is 0, 1, 2, 3 or 4; substituent Z is a carboxamide —CONH₂, p is 0, 1, 2, 3 or 4; substituent Q is a sulfonamide —SO₂NH₂, v is 0, 1, 2, 3 or 4; wherein the organic compound of the second type forms board-like supramolecules via π-π-interaction, and the retardation plates are substantially transparent to electromagnetic radiation in the visible spectral range.

7. A polarizer according to any of claim 4 or 5, wherein the retardation negative C-plate comprises at least one organic polymer compound of the general structural formula III: 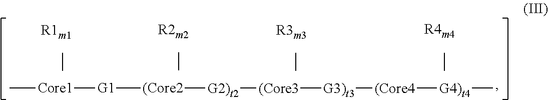
comprising n organic units, wherein the number n is an integer in the range from 5 to 1000, wherein the organic unit comprises conjugated organic components Core1, Core2, Core3 and Core4 capable of forming a rigid rod-like macromolecule, and where G1, G2, G3 and G4 are spacers selected from the list comprising —C(O)—NH—, —NH—C(O)—, —N═(C(O))2=, —O—NH—, linear and branched (C1-C4)alkylenes, linear and branched (C1-C4)alkenylenes, —O—CH2-, —CH2—O—, —CH═CH—, —CH═CH—C(O)O—, —O(O)C—CH═CH—, —C(O)—CH2-, —OC(O)—O—, —OC(O)—, —C≡C—, —C(O)—S—, —S—, —S—C(O)—, —O—, —NH—, —N(CH3)-; R1, R2, R3 and R4 are lyophilic side-groups providing solubility to the organic polymer compound or its salts in a suitable solvent and which are the same or different and independently selected from the list comprising —COOM, —SO₃M, —HMPO₃ and -M₂PO₃ for water or water-miscible solvent where counterion M is selected from a list comprising H⁺, Na⁺, K⁺, Li⁺, Cs⁺, Ba²⁺, Ca²⁺, Mg²⁺, Sr²⁺, Pb²⁺, Zn²⁺, La³⁺, Ce³⁺, Y³⁺, Yb³⁺, Gd³⁺, Zr⁴⁺ and NH₄₋ₖQₖ⁺, where Q is independently selected from the list comprising linear and branched (C1-C20) alkyl, (C2-C20) alkenyl, (C2-C20) alkinyl, and (C6-C20)arylalkyl, and k is 0, 1, 2, 3 or 4, and linear and branched (C1-C20) alkyl, (C2-C20) alkenyl, and (C2-C20) alkinyl for organic solvent; m1, m2, m3 and m4 are numbers of the lyophilic side-groups R1, R2, R3 and R4 in the conjugated organic components Core1, Core2, Core3 and Core4 accordingly which sum m=m1+m2+m3+m4 is equal to 0, 1, 2, 3, 4, 5, 6, 7, or 8; t2, t3 and t4 are numbers which are independently equal to 0 or 1, and wherein the solid optical retardation layer is a negative C-type or Ac-type plate substantially transparent to electromagnetic radiation in the visible spectral range.

8. A liquid crystal display comprising
a liquid crystal cell, and
front and rear polarizers arranged on each side of the liquid crystal cell,
wherein the polarizers have transmission axes which are perpendicular to each other,
at least one of said polarizers comprises at least one substrate made of a birefringent material and a polarizing plate located on the substrate,
the substrate possesses anisotropic property of positive A-type and has a slow optical axis parallel to the substrate surface,
the polarizing plate possesses anisotropic absorption of the electromagnetic radiation in at least one subrange of the visible spectral range, and
a transmission axis of the polarizing plate and the slow optical axis of the substrate are substantially parallel to each other.

9. A liquid crystal display according to claim 8, wherein the substrate birefringent material is selected from the list comprising poly ethylene terephtalate (PET), poly ethylene naphtalate (PEN), polyvinyl chloride (PVC), polycarbonate (PC), oriented poly propylene (OPP), poly ethylene (PE), polyimide (PI), and poly ester.

10. A liquid crystal display according to claim 8, wherein at least one said polarizer comprises two substrates, and wherein the polarizing plate is sandwiched between these substrates.

11. A liquid crystal display according to claim 8, wherein at least one said polarizer comprises a retardation plate, wherein type of the retardation plate is selected from the list comprising negative C type, negative A type, and B_{A} type

12. A liquid crystal display according to claim 11, wherein the liquid crystal cell is a vertical alignment mode liquid crystal cell, and the front polarizer comprises the retardation plate of the negative C-type.

13. A liquid crystal display according to claim 11, wherein the liquid crystal cell is an in-plane switching mode liquid crystal cell, and the front polarizer comprises the retardation plate of B_{A}-type or the retardation plate of negative A-type.

14. A liquid crystal display according to claim 8, wherein at least one polarizer comprises the polarizing plate based on a stretched polyvinyl alcohol (PVA).
